(19) United States
(12) Patent Application Publication
(10) Pub. No.: US 2017/0106893 A1
(43) Pub. Date: Apr. 20, 2017

(54) TURNING DEVICE FOR A STEERED WHEEL OF A ROLLING MACHINE

(71) Applicant: POCLAIN HYDRAULICS INDUSTRIE, VERBERIE (FR)

(72) Inventors: Stephane VIDAL, VERBERIE (FR); Sylvain MICHON, VERBERIE (FR); Paulo FERREIRA, VERBERIE (FR); Jean HEREN, VERBERIE (FR); Roman PREDNY, VERBERIE (FR)

(21) Appl. No.: 15/290,987

(22) Filed: Oct. 11, 2016

(30) Foreign Application Priority Data
Oct. 19, 2015 (FR) 1559948

(51) Int. Cl. B62D 1/10; G01D 5/14; B62D 6/10; B62D 5/065; B62D 15/02

(52) U.S. Cl. CPC B62D 1/10; B62D 5/065; B62D 15/0225; B62D 6/10; G01D 5/14

(57) ABSTRACT

The invention relates to a turning device for a steered wheel of a rolling machine, the device including:
a yoke (20),
an assembly (10) for mounting the steered wheel, including an end piece (11) intended to be attached to the steered wheel, and an intermediate connecting member (300), relatively to which the end piece (11) is mounted so as to rotate around a first axis (13) of rotation of the steered wheel,
a support (12) pivotally mounted around a second axis (23) of rotation relatively to the yoke (20) according to a turning angle (ANG) of the wheel, the second axis (23) of rotation being distinct and not parallel to the first axis (13) of rotation of the steered wheel,
a turning angle sensor (30),
one from among the support (12) and the yoke (20) being attached to the intermediate connecting member (300) and the other one from among the support (12) and the yoke (20) being intended to be attached to a fixed portion (C, E) of the rolling machine.

The invention is characterized in that the turning angle sensor (30) is a contactless sensor between the yoke (20) and the support (12).

The invention relates to a turning device for a steered wheel of a rolling machine.

A field of application of the invention notably relates to agricultural machines, such as for example harvesters-threshers.

A turning device is for example known from document FR-B-2 693 154.

In agricultural machines, direction sensors give the possibility of measuring the turning angle for adjusting the trajectory of the machine according to the required set value. In the harvester-thresher application, these hydraulic motors are mounted on the rear axle which gives the possibility of steering.

Such turning angle sensors formed with a potentiometer are known.

The rotation of the potentiometer allows measurement of the turning angle.

A drawback is that, in addition to turning with each other, the parts may translate on the axis of the measurement because of the deformation under the load of the engine.

Consequently, known devices require a complex and expensive mechanism for carrying out the measurement of the angle by avoiding this deformation.

Further, as the potentiometer is located at the lower end of the engine, it is very vulnerable to outer aggressions and requires a protective hood. The wires leaving this sensor also have to be protected, which is presently achieved by a very expensive and unesthetical metal tube.

The potentiometer is generally coupled with the rotating portion through an additional transmission part, for example a driving finger.

The invention is aimed at obtaining a turning device for a steered wheel of a rolling machine, for example an agricultural machine, or a building site machine, or an automobile vehicle, remedying the drawbacks of the state of the art.

For this purpose, a first object of the invention is a turning device for a steered wheel of a rolling machine, the device including:

a yoke,

an assembly for mounting the steered wheel, including an end piece intended to be attached to the steered wheel, and an intermediate connecting member, relatively to which the end piece is mounted so as to rotate around a first axis of rotation of the steered wheel,

a support pivotally mounted around a second axis of rotation relatively to the yoke according to a turning angle of the wheel, the second axis of rotation being distinct and not parallel to the first axis of rotation of the steered wheel,

a turning angle sensor,

one from among the support and the yoke being attached to the intermediate connecting member and the other one from among the support and the yoke being intended to be attached to a fixed portion of the rolling machine,

characterized in that the turning angle sensor is a contactless sensor between the yoke and the support.

Thanks to the invention, the number of parts required for measuring the angle is reduced. The parts of the device may deform without influencing the measurement of the turning angle. The sensor does not require any complex and expensive machining for its implantation.

According to an embodiment, the turning angle sensor is magnetic.

According to an embodiment, the turning angle sensor includes a first target module capable of generating a first physical quantity varying with the turning angle, and a second detection module for detecting the physical quantity of the first module, varying with the turning angle,

the first target module being attached to one from among the yoke and the support, the second detection module being attached to the other one from among the yoke and the support,

the second detection module being without any contact with the first target module.

According to an embodiment, the first target module is capable of generating as a physical quantity a magnetic field, the second detection module being capable of detecting a variation of the magnetic field of the first target module, varying with the turning angle.

According to an embodiment, a non-zero distance along the second axis of rotation is present between the first target module and the second detection module.

According to an embodiment, the yoke includes a core attached to a first arm and to a second arm, which are at a distance from each other and between which the support is pivotally mounted, the first target module or the second detection module being located in the first arm,

wherein the core and/or the first arm and/or the second arm is intended to be attached to the fixed portion of the rolling machine.

According to an embodiment, the first arm includes a first pivot having a first surface located facing a second surface of the support in a direction of the second axis of rotation, the support having mounting means allowing pivoting of the support relatively to the pivot around the second axis of rotation,

the first target module of the turning angle sensor being located on one from among the first surface and the second surface, the second detection module being located on the other one from among the first surface and the second surface.

According to an embodiment, the second arm includes a second pivot, relatively to which the support is pivotally mounted around the second axis of rotation, the first arm being located further lower relatively to the second arm in an attachment position of the other one from among the support and the yoke to the fixed portion of the rolling machine.

According to an embodiment, the first pivot protrudes into a cavity of the support, at least partly delimited by the first and second surfaces and by sealing means located between the first arm and the support, the first pivot or the support including at least one conduit for supplying a lubricant into the cavity, intended to be connected to a lubricator.

According to an embodiment, the first pivot protrudes into a first cavity of the support, at least partly delimited by the first and second surfaces, sealing means being interposed between the first cavity and a second cavity delimited by a lateral surface of the first pivot and an inner lateral surface of the support, the first pivot or the support including at least one conduit for supplying lubricant in the second cavity, intended to be connected to a lubricator.

According to an embodiment, the first pivot includes a recess for housing the first target module or the second detection module on its first surface and means for attachment of said first target module or second detection module in the recess.

According to an embodiment, the second detection module is connected to electric connection wires passing in a conduit of one from among the support and the yoke, for connecting the turning angle sensor to the outside.

According to an embodiment, the intermediate connecting member contains a motor for setting the end piece into rotation around the first axis of rotation.

A second subject matter of the invention is a rolling machine, including a chassis to which is attached the yoke of the turning device as described above and at least one steered wheel attached to the end piece of the turning device, the support being attached to the intermediate connecting member.

A third subject matter of the invention is a rolling machine, including an axle attached to the support of the turning device as described above, and at least one steered wheel attached to the end piece of the turning device, the yoke being attached to the intermediate connecting member.

A fourth subject matter of the invention is a method for mounting the turning device as described above, characterized in that

the turning angle sensor includes a first target module, capable of generating a first physical quantity varying with the turning angle, and a second detection module for detecting the physical quantity of the first target module, varying with the turning angle,

the second detection module being without any contact with the first target module, the yoke includes a core attached to a first arm and to a second arm, which are at a distance from each other,

the core and/or the first arm and/or the second arm being intended to be attached to a fixed portion of the rolling machine,

the first arm includes a first pivot,

during a first step, the second detection module or the first target module of the turning angle sensor is attached on a first surface of the first pivot,

during a second step, the first target module or the second detection module of the turning angle sensor is attached on a second surface of the support,

and then during a fourth step, the first pivot is placed in the first arm of the yoke in order to protrude into a cavity of the support placed between the first arm and the second arm, with the first surface of the first pivot located facing the second surface of the support in the direction of the second axis of rotation,

and then during a fifth step, the first pivot is attached in the first arm of the yoke,

the first step being carried out before the second step, or after the second step or simultaneously with the second step.

The invention will be better understood upon reading the description which follows, only given as a non-limiting example with reference to the appended drawings, wherein:

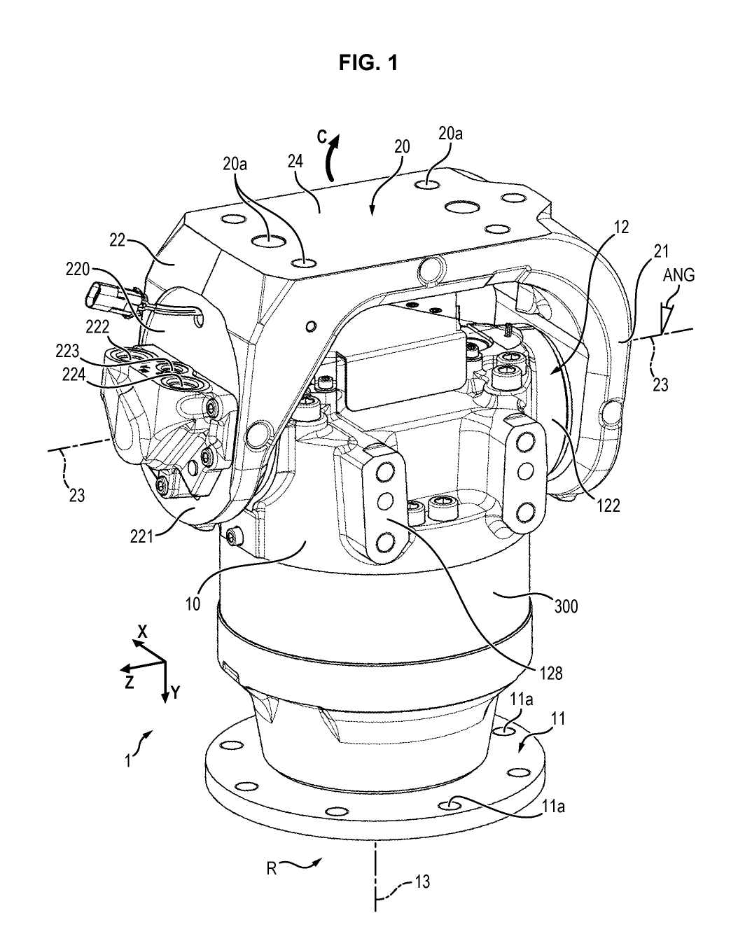

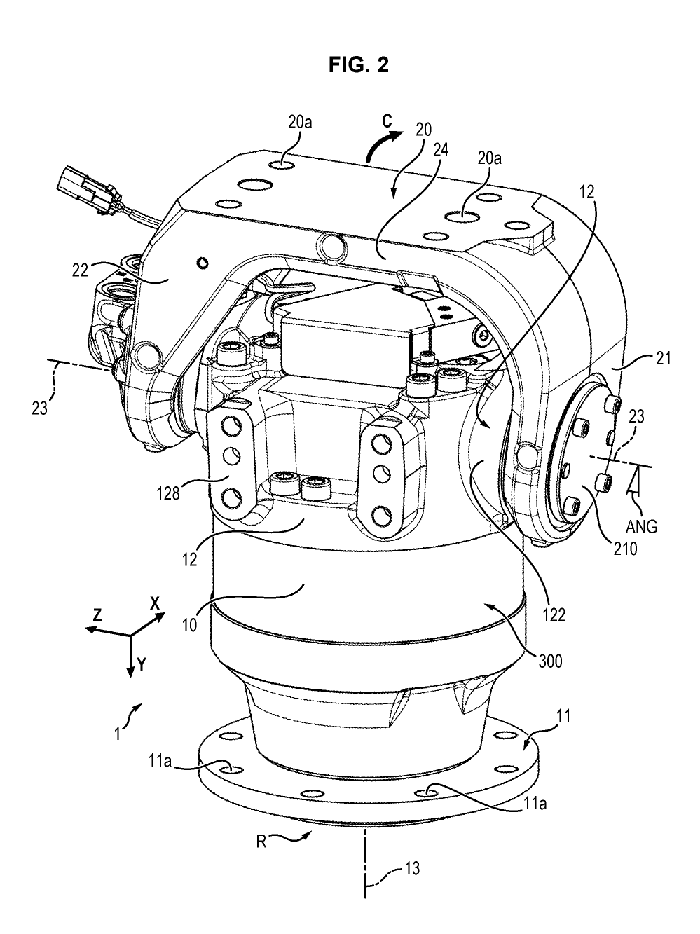

FIGS. 1 and 2 are two schematic perspective views of the turning device according to an embodiment of the invention,

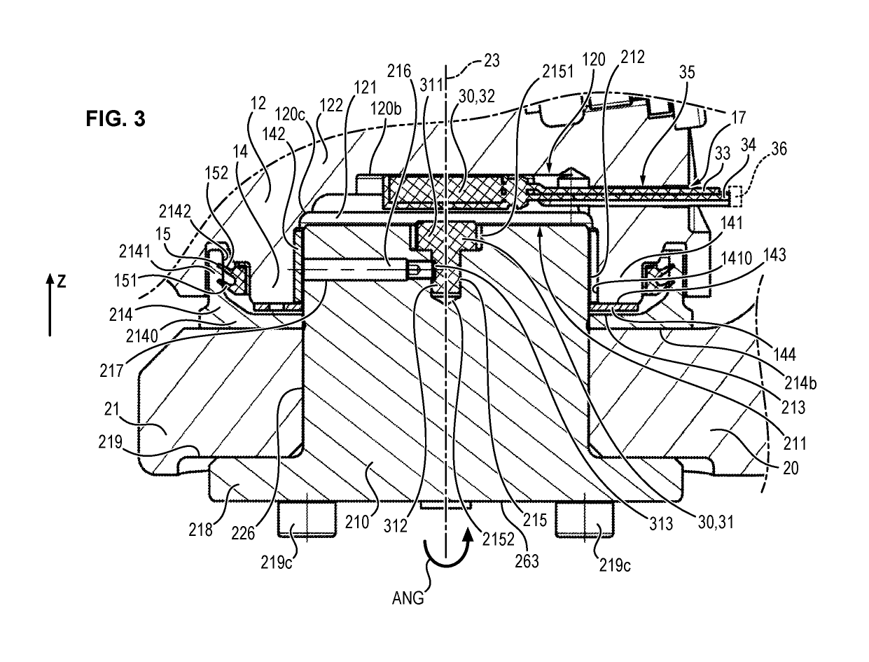

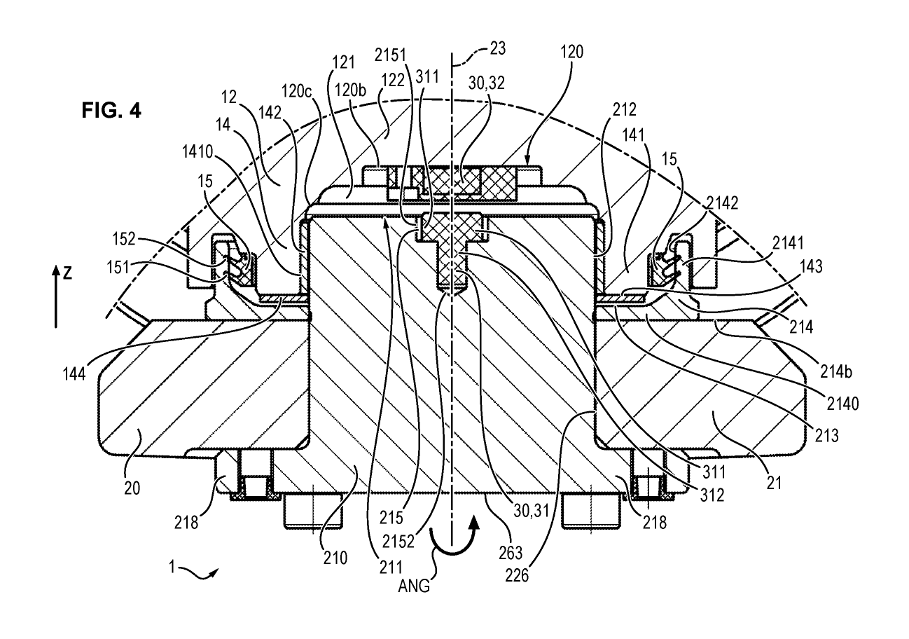

FIGS. 3, 4 and 5 are three schematic cross-sectional views along three different sectional planes passing through the second axis of rotation of the turning device according to an embodiment,

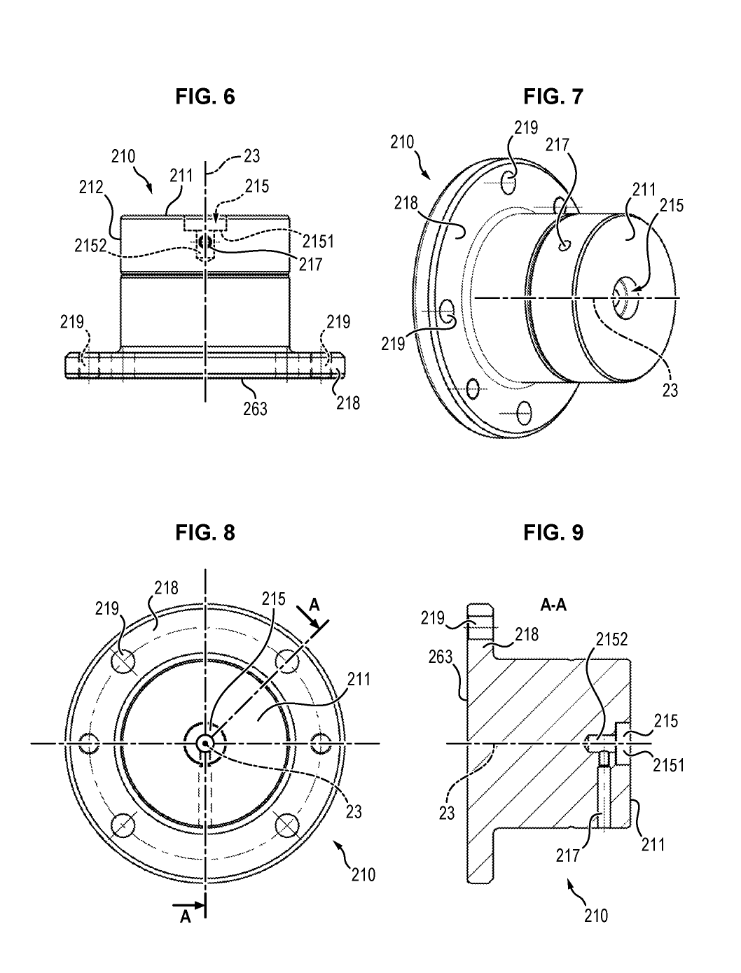

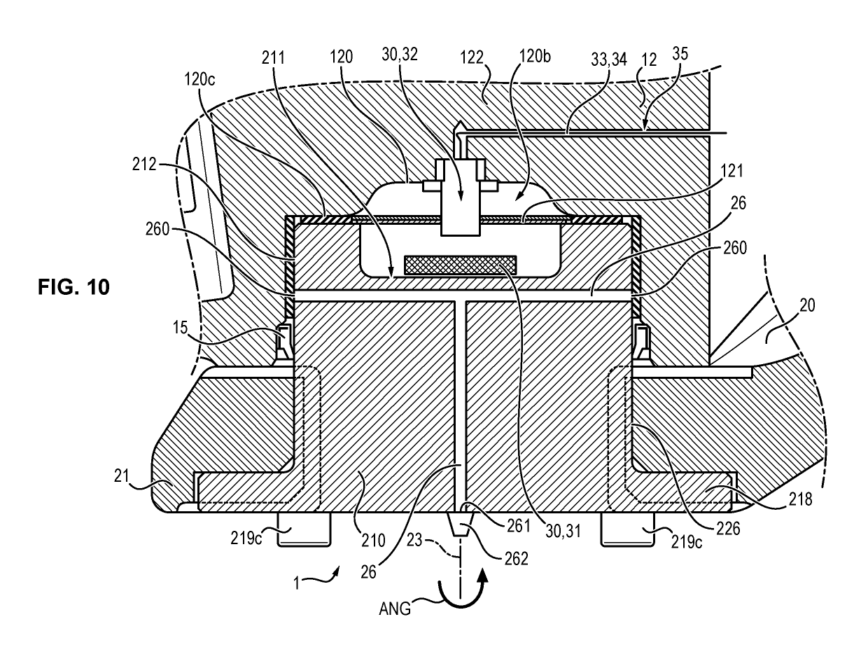

FIGS. 6, 7, 8 and 9 are respectively side, perspective, front and cross-sectional views of a pivot of the turning device according to an embodiment of the invention,

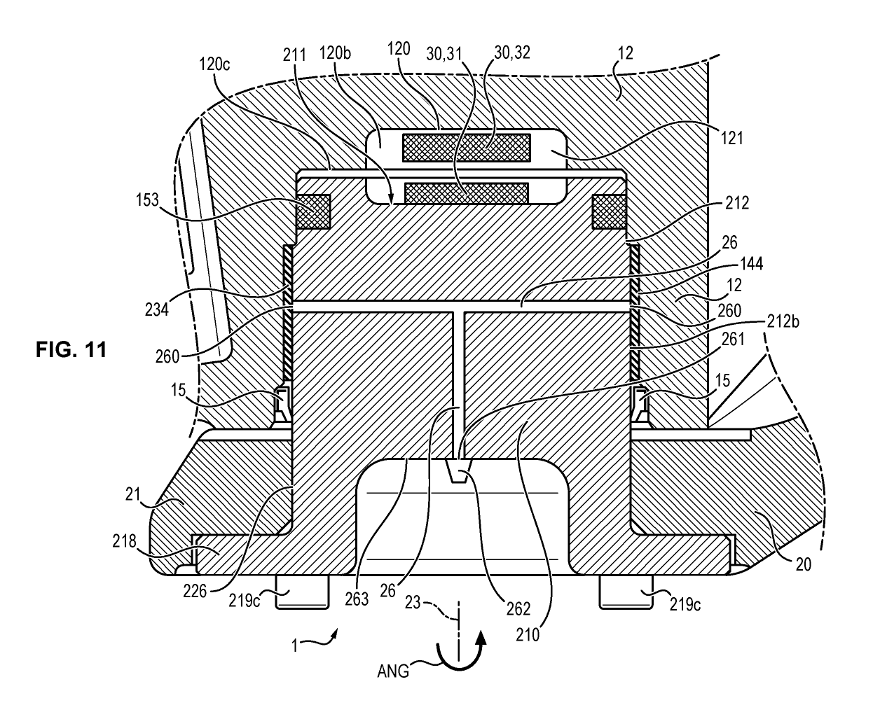

FIGS. 10, 11 and 12 are schematic sectional views of the turning device according to embodiments of the invention,

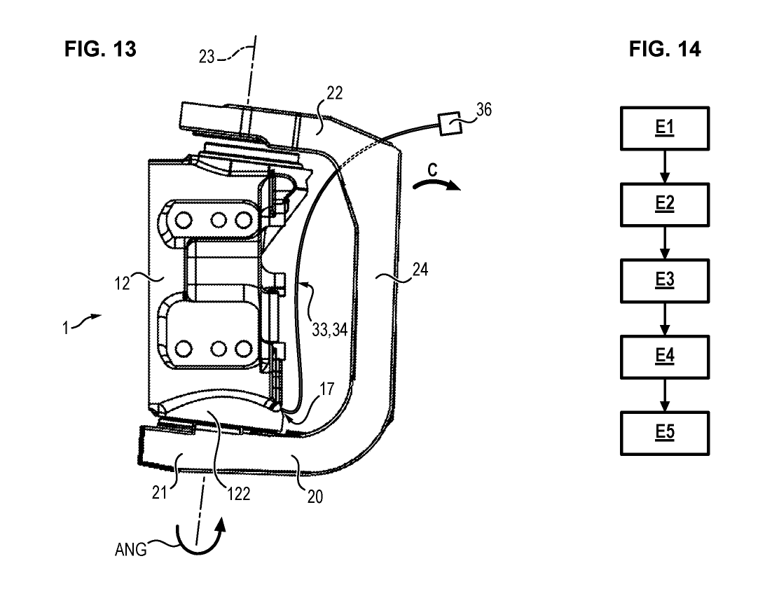

FIG. 13 is a schematic outer side view of the turning device according to an embodiment of the invention,

FIG. 14 is a flow chart of steps for mounting the device according to an embodiment of the invention,

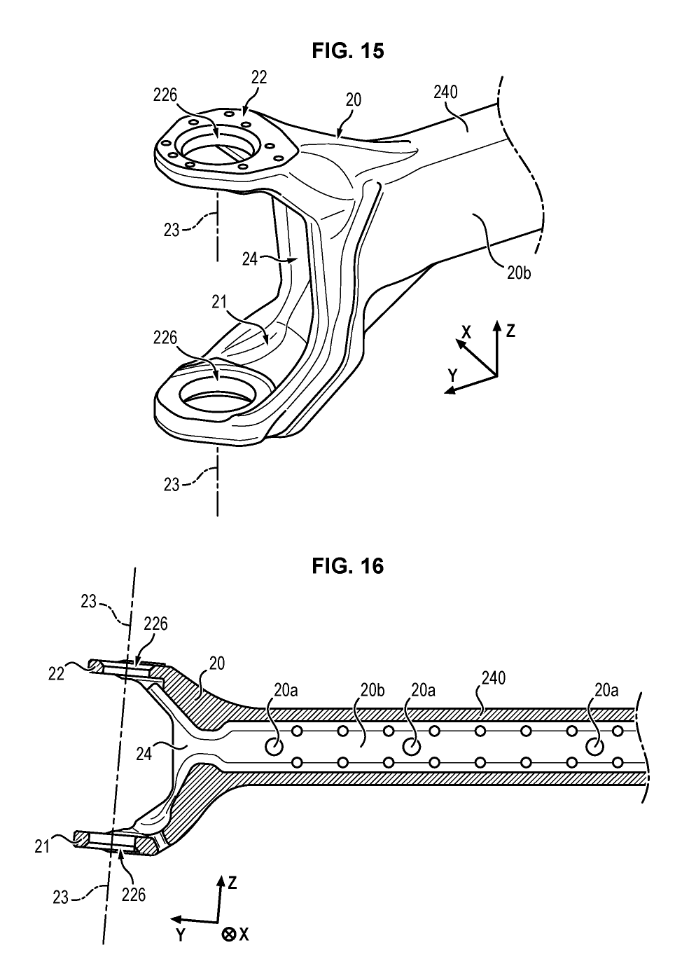

FIGS. 15 and 16 are schematic perspective and side views of a yoke of the turning device according to an embodiment of the invention,

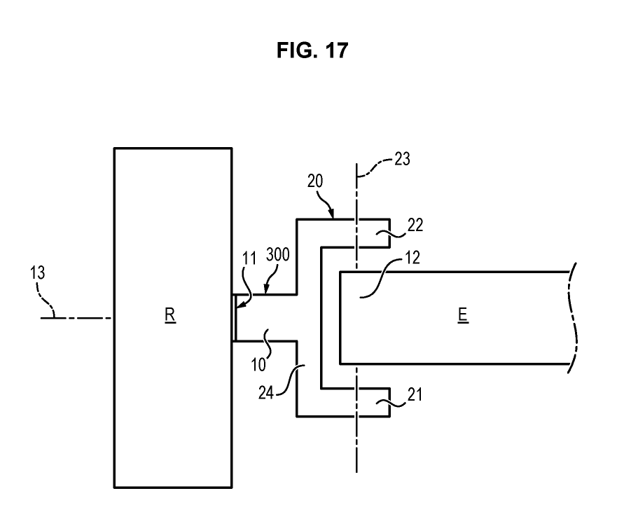

FIG. 17 is a schematic sectional view of an alternative of the turning device according to an embodiment of the invention in an alternative relatively to FIGS. 1 and 2.

In FIGS. 1 to 17, the turning device 1 according to the invention is used for turning a steered wheel R of a rolling machine according to different orientation directions of the wheel, in order to have the machine assume different directions. The steered wheel R is intended to be in contact with the ground. This is therefore a machine rolling on the ground, the steered wheel(s) R of which directly roll on the ground. The rolling machine may for example be an agricultural vehicle, such as for example a harvester-thresher, or any other type of vehicle, such as for example a building site machine or an automobile vehicle. The steered wheel R may be a front wheel or a rear wheel. The machine for example includes two steered wheels R at the front or at the rear, which may each be provided with the turning device, and for example two rear steered wheels R in the case of a harvester-thresher. The steered wheel may be driven, for example hydraulically, such as for example in the case of a harvester-thresher. Of course, in other embodiments, the steered wheel R may not be driven.

The rolling machine includes a chassis C and/or an axle E, not shown, relatively to which the steered wheel R, not shown, may rotate on itself on the ground. The first axis 13 of rotation of the steered wheel R is substantially horizontal.

The steered wheel R is intended to be attached to an end piece 11 of the device 1. This end piece 11 is for example disc-shaped which may include means 11a for attachment to the steered wheel R, for example including bolts.

The end piece 11 is mounted so as to rotate around the first axis 13 of rotation relatively to an intermediate connecting member 300. The end piece 11 and the intermediate connecting member 300 are part of an assembly 10 for mounting the steered wheel R. Between the part 11 and the intermediate connecting member 300 are placed means forming a bearing well known to one skilled in the art, and not detailed here.

The device further includes a support 12, which is pivotally mounted around a second axis 23 of rotation relatively to a yoke 20 according to a turning angle ANG of the steered wheel R. The second axis 23 of rotation is therefore a turning and/or steering axis 23. The second axis 23 of rotation is distinct from the first axis 13 of rotation of the steered wheel and is not parallel to this first axis 13 of rotation. The second axis 23 of rotation is for example non-secant and non-parallel to the first axis 13 of rotation of the steered wheel. The second axis 23 of rotation may for example be vertical or substantially vertical. In an embodiment, both of these axes 13 and 23 are substantially perpendicular, but may have a slight angle, selected according to the dimensions of the wheel and on the desired geometry for the machine, for example a camber angle.

One from among the support 12 and the yoke 20 is attached to the intermediate connecting member 300. The other one from among the support 12 and the yoke 20 is intended to be attached to a fixed portion of the rolling machine.

This fixed portion may for example be a fixed chassis C of the rolling machine in a first configuration according to FIGS. 1 and 2. This fixed portion may for example be a fixed axle E of the rolling machine in a second configuration according to FIG. 17. The axle E is fixed relatively to the chassis C.

In the first configuration according to FIGS. 1 and 2, the yoke 20 is intended to be attached to the chassis of the rolling machine. The support 12 is attached to the intermediate connecting member 300. For example, attachment means 20a may be provided, which for example include bolts, for attaching the yoke 20 to the chassis C.

In the second configuration according to FIG. 17, the support 12 is intended to be attached to the axle E of the rolling machine and the yoke 20 is attached to the intermediate connecting member 300.

The embodiments described below are described with reference to FIGS. 3 to 16 and may be combined with the first configuration according to FIGS. 1 and 2, or with the second configuration according to FIG. 17. According to an embodiment according to the first and/or second configuration, the intermediate connecting member 300 contains a motor giving the possibility of controlling the rotation of the end piece 11 around the axis 13 in order to ensure traction or displacement of the rolling machine. The motor may be of different natures, but preferentially a hydrostatic machine with positive displacement. The motor may be hydraulic. It may in particular be a machine with axial or radial pistons. It may directly drive the wheel R, or include a gear reduction stage. Preferentially, this is a motor with a multilobe cam and radial pistons rotating at the speed of the wheel. The intermediate connecting member 300 for example has a general circular cylindrical outer shape around the first axis 13 of rotation and may be formed by the outer stator or the outer case of the motor. According to this embodiment, the end piece 11 is driven and therefore the wheel R is a driven wheel. Of course, in other embodiments of the first and/or second configuration, the end piece 11 and therefore the wheel R may be non-driven wheels or else without any motor at the wheel.

According to another embodiment according to the first and/or second configuration, a rotary shaft relatively to the intermediate connecting member 300 is provided in the latter for driving into rotation the end piece 11 and therefore the wheel R around the first axis 13. This shaft is driven into rotation by a motor located on the side of the fixed portion, for example the chassis C or the axle E, optionally via transmission means (for example a cardan transmission, the shaft crossing the yoke for example) between the motor and the shaft.

According to an embodiment, the intermediate connecting member 300 bears an attachment element for directing the rotation of the support 12 relatively to the yoke 20 around the axis 23 according to a turning rotation angle command, or steering command. The attachment element is at a distance from the axis 23 and may be jointed on the intermediate connecting member 300, for example on a portion 128 of the latter. This attachment element may include a steering connecting rod, jointed with the intermediate connecting member 300 at a distance from the axis 23, the intermediate connecting member 300 including a member for receiving the connecting rod, such as for example a lug. This rotation angle command is sent, via a control assembly, from a control interface actuated by the user for imposing the value of the position in rotation of the steered wheel, selected by the user around the axis 23. This control interface can for example be a steering wheel. The control assembly may include a steering rack as used on lightweight automobile vehicles or on small machines such as mowers, or a hydraulic steering actuator as used on agricultural or building site machines, or any known command for pivoting a steered wheel around the axis 23.

The turning device 1 includes a turning angle ANG sensor 30. The sensor 30 gives the possibility of measuring the actual rotation angle ANG of the support 12 relatively to the yoke 20 around the second axis 23 of rotation. For example, the turning angle ANG is an angular displacement taken relatively to an angular position reference of the support 12, and therefore of the end piece 11 and of the steered wheel around the second axis 23 of rotation.

According to the invention, the turning angle sensor 30 is a contactless sensor between the yoke 20 and the support 12 and/or between the pivot 210 and the support 12.

This turning angle sensor 30 may be magnetic.

According to an embodiment, the turning angle sensor 30 includes a first target module 31, capable of generating a first physical quantity varying with the turning angle ANG, and a second detection module 32 for detecting the physical quantity of the first module 31, varying with the turning angle ANG.

According to an embodiment, for example in FIGS. 3, 4, 5, 10 and 11, the first target module 31 is attached to the yoke 20, for example to the pivot 210 connected to the yoke 20, while the second detection module 32 is attached to the support 12.

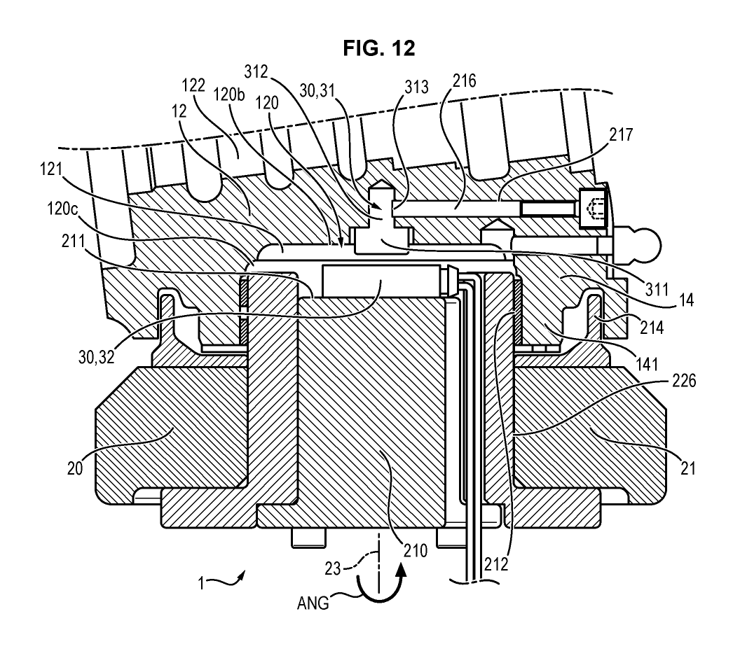

In another embodiment, as for example in FIG. 12, the first target module 31 is attached to the support 12, while the second detection module 32 is attached to the yoke 20 (or to the pivot 210). This configuration has the advantage that the wires of the module 32 are not folded at each rotation of the support 12 relatively to the yoke 20 around the axis 23.

The second detection module 32 is without any contact with the first target module 31.

Thus, there is no electric contact, or mechanical contact between the first target module 31 and the second detection module 32. On the contrary there is a non-zero space between the first target module 31 and the second detection module 32. This space for example comprises at least one non-zero distance along the second axis 23 of rotation between the first target module 31 and the second detection module 32. The second detection module 32 may for example be facing the first target module 31 in the direction of the second axis 23 of rotation. According to an embodiment, the distance between the first module and the second module is selected so as to be sufficient so that there is no collision between the first module and the second module.

Thus, one gets rid of the risks of deformation causing a translation of the support 12 and of the yoke 20 along the axis 23 of rotation, which may cause the modules 31 and 32 to move closer to one another along this axis 23.

According to an embodiment, the distance between the first target module 31 and the second detection module 32 is variable, without any impact on the measurement of the angle ANG. This is one of the advantages of this solution contrary to a mechanical solution with a contact which requires a complicated mechanical system and which is subject to wear.

According to an embodiment, in the case of a magnetic sensor 30, the physical quantity generated by the first target module 31 is a magnetic field, which varies according to the turning angle. The second detection module 32 is configured for detecting a variation of the magnetic field generated by the first target module 31. The second module 32 may thus obtain from the variation of magnetic field, the angular displacement of the support 12 around the axis 23 relatively to the yoke 20. The measurement of the turning angle ANG is obtained from this magnetic field variation.

According to an embodiment, the yoke 20 includes a core 24 intended to be attached to the fixed portion of the rolling machine (which may be its chassis C or its axle E). This core 24 therefore includes the means 20a for attachment to this fixed portion of the rolling machine. The yoke 20 further includes a first arm 21 and a second arm 22, which are attached to the core 24. The arms 21 and 22 are distant from one another and located facing each other along the axis 23 of rotation. The yoke 20 may be C-shaped or U-shaped. The support 12 is pivotally mounted between the first arm 21 and the second arm 22 around the axis 23 of rotation.

According to an embodiment, illustrated in FIGS. 15 and 16, the core 24 includes an extension 240 bearing the attachment means 20a, the extension 240 moving away from the arms 21 and 22. For example, the extension 240 includes an attachment plate 20b intended to receive the attachment means 20a, which may be or include for example bolts, and to be placed on a planar portion of the machine facing its fixed portion (which may be its chassis C or its axle E), in order to ensure attachment.

A joint portion 122 of the support 12 on the arm 21 around the second axis 23 is described below with reference to FIGS. 3 to 12. Below, the different mentioned portions of the support 12 belong to this joint portion 122.

According to an embodiment, the first target module 31 or the second detection module 32 is located in the first arm 21.

According to an embodiment, the first arm 21 and the support 12 respectively have surfaces 211 and 120 located facing each other in the direction of the axis 23 of rotation, and this for all the positions in rotation of the support 12 relatively to the yoke 20 around the axis 23. The surface 211 and/or 120 is for example transverse to the axis 23. The first target module 31 of the sensor 30 is located on the first surface 211 or on the second surface 120, while the second detection module 32 of the sensor 30 is located on the second surface 120 or on the first surface 211.

According to an embodiment in FIGS. 3 to 12, the first arm 21 includes a first pivot 210 having the first surface 211 located facing the second surface 120 of the support 12 in the direction of the second axis 23 of rotation. The pivot 210 is attached to the first arm 21. The second axis 23 of rotation passes through the first pivot 210. The support 12 includes mounting means 14 allowing pivoting of the support 12 relatively to the pivot 210 around the second axis 23 of rotation. The support 12 for example includes the joint portion 122 forming a bearing surrounding the pivot 120. This joint portion 122 for example includes the elements 14, 15 described below.

Of course, the first target module 31 may, in other embodiments, be located on the second surface 120, and the second detection module 32 may be located on the first surface 211, in other embodiments, such as for example in FIG. 12.

Thus, during the rotation of the support 12 relatively to the arm 21 around the axis 23, the first target module 31 is located facing the second detection module 32. For example, the central axis 23 of rotation passes through the first target module 31 and/or through the second detection module 32.

According to an embodiment, the first target module 31 includes one or several magnets or magnetic poles. In the case of several magnets or several magnetic poles, the latter are distributed around the axis 23 of rotation. The second detection module 32 may be a module with the Hall effect.

According to an embodiment, the second arm 22 includes a second pivot 220. The pivot 210 and/or 220 defines the axis 23. The second axis of rotation 23 passes through the centre of the pivot 210 and/or 220. The pivot 210 is for example a low pivot, while pivot 220 is for example a high pivot.

The support 12 is pivotally mounted relatively to the second pivot 220 around the second axis 23 of rotation. The first arm 21 is located in a lower position relatively to the second arm 22, when the yoke 20 is attached to the fixed portion of the rolling machine. The arm 22 and the pivot 220 are located in a high position, while the arm 21 and the pivot 210 are located in a low position, in the attachment position of the yoke 20 to the fixed portion. Of course, it is possible, in another embodiment, that the first arm 21 be located in a higher position relatively to the second arm 22, when the yoke 20 is attached to the fixed portion of the rolling machine.

According to an embodiment, the means 14 for mounting the support 12 relatively to the pivot 210 include a collar 141 surrounding a lateral surface 212, for example a circular cylindrical surface 212, of the pivot 210 around the axis 23 of rotation. This collar 141 includes on its inner surface 1410, which is for example circular cylindrical and which is turned towards the lateral surface 212 of the pivot 210, one or several bearing bushes 142 for abutment in rotation, being used as a lateral support for the surface 212. The peripheral collar 141 further includes a front surface 143, transverse to the axis 23 of rotation, on which are found one or several other axial abutment bearing bushes 144, along the axis 23 of rotation, for another front surface 213 of the arm 21, transverse to the axis 23. The surface 213 is for example provided on an intermediate part 214 fixed against a transverse inner surface 214b of the arm 21, the part 214 being found between the arm 21 and the support 12. The arm 21 includes a hole 226, for example a circular cylindrical hole, for the crossing of the pivot 210 in the direction of the axis 23 of rotation.

The sensor according to the invention allows to let free the second axis 23 of rotation. Thus, according to an embodiment, it is possible to implant a greasing system 26 through this second axis 23 of rotation, as this will be described below. The grease thereby arrives directly at the middle of the connection. Thus, this solution is completely integrated in the first pivot 210.

In an embodiment, the pivot 210 protrudes into a cavity 121 of the support 12. The cavity 121 is used for housing the module 32 or 31 of the sensor 30. The surface 120 for example includes a recess 120b, running away from the yoke 20 and/or from the pivot 210, in the direction of the second axis 23 of rotation, the module 32 or 31 being housed and attached in this recess 120b. The surface 120 for example includes another portion 120c closer to the pivot 210 along the axis 23, beside or around the recess 120b, this portion 120c facing the surface 211 of the pivot 210 in the direction of the axis 23. The lateral surface 212 therefore juts out from the hole 226 of the arm 21 towards the support 12 and therefore juts out from the part 214 in the direction of the axis 23 of rotation. Sealing means 15 are located between the arm 21 and the support 12 all around the axis 23. These sealing means 15 are for example attached to the support 12. The part 214 protrudes into the support 12 around the pivot 210. The part 214 includes a base 2140 attached against the inner surface 214b of the arm 21. On the base 2140 is the surface 213 for axial abutment of the bearing bush 144. The part 214 includes a ring 2141, which is peripheral to the base 2140 and which protrudes towards the support 12 in the direction of the axis 23 of rotation, at a distance from the outer lateral surface 212 of the pivot 210. This ring 2141 has an inner lateral surface 2142, which is parallel to the axis 23, which is for example circular cylindrical and which is used as a support for one or several flexible lips 151, 152 of the sealing means 15. The sealing means 15 are for example formed by a seal gasket. The sealing means 15 thereby delimit with the surfaces 211 and 120, at least partly the cavity 121 of the support 12. The part 214 is preferably made in a part with great hardness for ensuring the friction with the sealing means 15.

According to an embodiment, like for example in FIG. 10, the first pivot 210 includes at least one conduit 26 crossing it, being used for supplying a lubricant, typically grease, in the cavity 121. The cavity 121 also extends around the pivot 210, between the lateral surface 212 and the inner lateral surface 1410, starting from the surfaces 120 and 211 as far as the sealing means 15. The conduit 26 includes at least one first end 260 opening into the cavity 121 between the pivot 210 and the support 12 and at least one second end 261 connected to a lubricator 262 outside the cavity 121, for example attached to the pivot 210 on its rear outer surface 263, away from the support 12. The lubricator is any object intended to insert lubricant. The lubricator may be an orifice provided with a removable plug, or a lubricator as an anti-return valve containing a bead and a spring, or a connection to an automatic greasing central unit, or any other type of system for supplying lubricant. The lubricant sent by the lubricator 262 into the conduit 26 penetrates into the cavity 121, for lubricating the rotation connection of the support 12 around the pivot 210. By means of the sensor 30 according to the invention, it is possible to directly supply the lubricant to the middle of this connection between the support 12 and the pivot 210, included against the sensor 30 and its modules 31 and 32. Indeed, by means of the sensor 30 according to the invention, the lubricant does not affect the operation of the sensor, does not influence the measurement of the turning angle conducted by the sensor 30 and may enter the environment of this sensor 30.

In another embodiment, like for example in FIG. 11, other sealing means 153 may be provided between the conduit 26 and the cavity 121. These sealing means 153 give the possibility of avoiding that the sensor 30 experiences a rise in pressure under the effect of the lubricant sent through the conduit 26. These sealing means 153 are for example provided on the lateral surface 212 of the pivot 210, the conduit 26 opening through its end(s) 260 into another cavity 234 located between the sealing means 153 and the sealing means 15, in order to send lubricant against the portion 212b of the lateral surface 212 located between the sealing means 15 and 153. The sealing means 153 are interposed between the first cavity 121 and the second cavity 214 delimited by the lateral surface 212b of the first pivot 20 and the inner lateral surface 1410 of the support 12. The conduit 26 brings the lubricant into the cavity 214. The sealing means 153 may be sealing segments or sealing rings, sealing gaskets, in particular multilobe ring gaskets or lip rings.

According to an embodiment, the first pivot 210 includes a recess 215 used for housing the first target module 31 or the second detection module 32 on the surface 211. The housing 215 is located facing the surface 120 and/or of the recess 120b in the direction of the axis 23 of rotation. For example, the first module 31 or the second module 32 inserted into the recess 215 includes a head 311 turned towards the other module 32 or 31 and towards the second surface 120, and a foot 312 less wide than the head 311 and used for the attachment in the recess 215. Means 216 for attaching the module 31 or 32 in the recess 215 are provided. The recess 215 includes an upper portion 2151 for housing the head 311 and a lower portion 2152 for housing the foot 312, the portion 2152 being located under the portion 2151. The attachment means 216 for example include a lateral screw 216 crossing a lateral internal thread 217 of the pivot 210, opening into the lateral surface 212. The foot 312 may include a lateral notch 313 with a flat surface, against which the screw 216 bears in order to attach the module 31 or 32 in the recess 215 and to prevent it from turning. The screw 216 is thus embedded in the pivot 210. The lateral notch 313 with the flat surface is indexed on the module 31 or 32 and allows it to be held and to prescribe its fixed angular orientation around the axis 23.

According to an embodiment, the second detection module 32 is connected to electric connection wires 33, 34. The wires 33, 34 pass into a conduit 35 of the support 12 or of the yoke 20, for connecting the sensor 30 to the outside. The wires 34, 35 are for example attached to a connector 36 at a distance from the module 32, this connector 36 gives the possibility of connecting the sensor 30 to a unit for receiving the measurement of the turning angle ANG, provided by the sensor 30, this receiving unit being part of the aforementioned control unit, which may then utilize this measurement of the angle ANG.

The pivot 210 includes an outer shoulder 218, which is radially wider relatively to the axis 23 than the lateral surface 212. This shoulder 218 is attached against the outer surface 219 of the arm 21, away from the support 12, the shoulder 218 being at a distance from the surface 211 and at a distance from the sensor 30. The outer peripheral shoulder 218 includes holes 219 allowing insertion of attachment screws 219c in corresponding holes 219b made in the outer surface 219d of the arm 21.

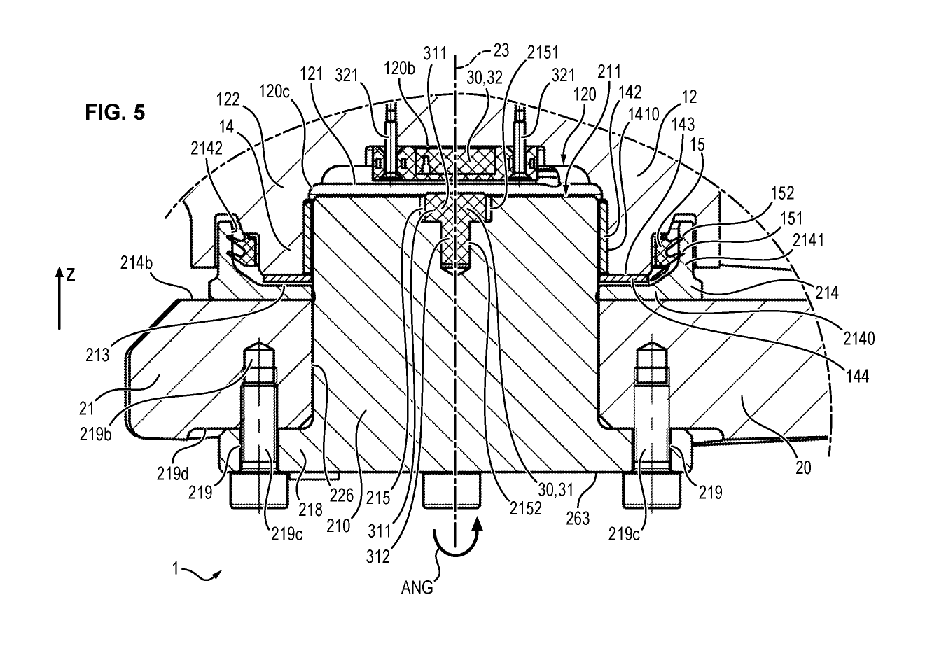

In an embodiment, illustrated in FIG. 5, the module 32 attached to the support 12 may include one or several screws 321 for attachment to the support 12 or other attachment means. These attachment means or attachment screws 321 are provided in the recess 120b.

The arm 22 may include on its outer surface 221 away from the support 12 connectors 222, 223, 224 to hydraulic fluid transport ducts towards and from the motor, for its control according to the turning angle.

A method for mounting the device 1 may be the following.

During a first step E1, the module 32 or 31 of the sensor 30 is placed and attached on the support 12, for example on the surface 120 according to one of the embodiments described above.

During a second step E2, the module 31 or 32 of the sensor 30 is placed and attached in the yoke, for example on the pivot 120 and/or 210 according to one of the embodiments described above.

Optionally, during a third step E3, a seal is achieved on the wires 33, 34 of the module 32, by the sealing means 17, such as for example a gasket and/or an adhesive.

During a fourth step E4, the pivot 210 is placed in the arm 21 of the yoke 20. This pivot 210 allows attachment of the support 12 in the yoke 20.

During a fifth step E5, the pivot 210 is attached in the arm 21 of the yoke 20, for example by the screws 219c.

The steps E1, E2, E3, E4 and E5 may successively be carried out in this order. Step E2 may be carried out after step E1, before step E1 or simultaneously with step E1.

According to an embodiment of the invention, the method for mounting the turning device is the following.

During the first step E1, the second or first module 32, 31 of the sensor 30 is attached on a first surface 211 of the first pivot 210.

During the second step E2, the first or second module 31, 32 of the sensor 30 is attached on a second surface 120 of the support 12.

And then during the fourth step E4, the first pivot 210 is placed in the first arm 21 of the yoke 20 in order to protrude into a cavity 121 of the support 12 placed between the first arm 21 and the second arm 22, with the first surface 211 of the first pivot 210 located facing the second surface 120 of the support 12 in the direction of the second axis 23 of rotation.

And then during the fifth step E5, the first pivot 210 is attached in the first arm 21 of the yoke 20.

1. A turning device for a steered wheel of a rolling machine, the device including:
a yoke (20),
an assembly (10) for mounting the steered wheel, including an end piece (11) intended to be attached to the steered wheel, and an intermediate connecting member (300), relatively to which the end piece (11) is mounted so as to rotate around a first axis (13) of rotation of the steered wheel,
a support (12) pivotally mounted around a second axis (23) of rotation relatively to the yoke (20) according to a turning angle (ANG) of the wheel, the second axis (23) of rotation being distinct and not parallel to the first axis (13) of rotation of the steered wheel,
a turning angle sensor (30),
one from among the support (12) and the yoke (20) being attached to the intermediate connecting member (300) and the other one from among the support (12) and the yoke (20) being intended to be attached to a fixed portion (C, E) of the rolling machine,
characterized in that the turning angle sensor (30) is a contactless sensor between the yoke (20) and the support (12),
the intermediate connecting member (300) containing a motor for setting the end piece (11) into rotation around the first axis (13) of rotation.

2. The device according to claim 1, wherein the turning angle sensor (30) is magnetic.

3. The device according to any one of the preceding claims, wherein the turning angle sensor (30) includes a first target module (31) capable of generating a first physical quantity varying with the turning angle (ANG), and a second detection module (32) for detecting the physical quantity of the first module (31), varying with the turning angle (ANG),
the first target module (31) being attached to one from among the yoke (20) and the support (12), the second detection module (32) being attached to the other one from among the yoke (20) and the support (12),
the second detection module (32) being without any contact with the first target module (31).

4. The device according to claim 3, wherein the first target module (31) is capable of generating as a physical quantity a magnetic field, the second detection module (32) being capable of detecting a variation of the magnetic field of the first target module (31), varying with the turning angle (ANG).

5. The device according to claim 3 or 4, wherein a non-zero distance along the second axis (23) of rotation is present between the first target module (31) and the second detection module (32).

6. The device according to any one of claims 3 to 5, wherein the yoke (20) includes a core (24) attached to a first arm (21) and to a second arm (22), which are at a distance from each other and between which the support (12) is pivotally mounted, the first target module (31) or the second detection module (32) being located in the first arm (21),
wherein the core (24) and/or the first arm (21) and/or the second arm (22) is intended to be attached to the fixed portion (C, E) of the rolling machine.

7. The device according to claim 6, wherein the first arm (21) includes a first pivot (210) having a first surface (211) located facing a second surface (120) of the support (12) in a direction of the second axis (23) of rotation, the support (12) having mounting means (14) allowing pivoting of the support (12) relatively to the pivot (210) around the second axis (23) of rotation,
the first target module (31) of the turning angle sensor being located on one from among the first surface (211) and the second surface (120), the second detection module (32) being located on the other one from among the first surface (211) and the second surface (120).

8. The device according to claim 7, wherein the second arm (22) includes a second pivot (220), relatively to which the support (12) is pivotally mounted around the second axis (23) of rotation, the first arm (21) being located further lower relatively to the second arm (22) in an attachment position of the other one from among the support (12) and the yoke (20) to the fixed portion (C, E) of the rolling machine.

9. The device according to any one of claims 7 and 8, wherein the first pivot (210) protrudes into a cavity (121) of the support (12), at least partly delimited by the first and second surfaces (211, 120) and by sealing means (15) located between the first arm (21) and the support (12), the first pivot (210) or the support (12) including at least one conduit (16, 26) for supplying a lubricant into the cavity (121), intended to be connected to a lubricator (262).

10. The device according to any one of claims 7 and 8, wherein the first pivot (210) protrudes into a first cavity (121) of the support (12), at least partly delimited by the first and second surfaces (211, 120), sealing means (153) being interposed between the first cavity (121) and a second cavity (234) delimited by a lateral surface (212b) of the first pivot (20) and an inner lateral surface (1410) of the support (12), the first pivot (210) or the support (12) including at least one conduit (16, 26) for supplying lubricant in the second cavity (234), intended to be connected to a lubricator (262).

11. The device according to any one of claims 7 to 10, wherein the first pivot (210) includes a recess (215) for housing the first target module (31) or the second detection module (32) on its first surface (211) and means (216) for attachment of said first target module (31) or second detection module (32) in the recess (215).

12. The device according to any one of claims 3 to 10, wherein the second detection module (32) is connected to electric connection wires (33, 34) passing in a conduit (35) of one from among the support (12) and the yoke (20), for connecting the turning angle sensor (30) to the outside.

13. A rolling machine, including a chassis (C) to which is attached the yoke (20) of the turning device according to any one of claims 1 to 12 and at least one steered wheel attached to the end piece (11) of the turning device, the support (12) being attached to the intermediate connecting member (300).

14. A rolling machine, including an axle (E) attached to the support (12) of the turning device according to any one of claims 1 to 12, and at least one steered wheel attached to the end piece (11) of the turning device, the yoke (20) being attached to the intermediate connecting member (300).

15. A method for mounting the turning device according to any one of claims 1 to 12, wherein
the turning angle sensor (30) includes a first target module (31), capable of generating a first physical quantity varying with the turning angle (ANG), and a second detection module (32) for detecting the physical quantity of the first target module (31), varying with the turning angle (ANG),
the second detection module (32) being without any contact with the first target module (31), the yoke (20) includes a core (24) attached to a first arm (21) and to a second arm (22), which are at a distance from each other,
the core (24) and/or the first arm (21) and/or the second arm (22) being intended to be attached to a fixed portion (C, E) of the rolling machine,
the first arm (21) includes a first pivot (210),
during a first step (E1), the second detection module (32) or the first target module (31) of the turning angle sensor (30) is attached on a first surface (211) of the first pivot (210),
during a second step (E2), the first target module (31) or the second detection module (32) of the turning angle sensor (30) is attached on a second surface (120) of the support (12),
and then during a fourth step (E4), the first pivot (210) is placed in the first arm (21) of the yoke (20) in order to protrude into a cavity (121) of the support (12) placed between the first arm (21) and the second arm (22), with the first surface (211) of the first pivot (210) located facing the second surface (120) of the support (12) in the direction of the second axis (23) of rotation,
and then during a fifth step (E5), the first pivot (210) is attached in the first arm (21) of the yoke (20),
the first step (E1) being carried out before the second step (E2), or after the second step (E2) or simultaneously with the second step (E2).
